(19) United States
(12) Patent Application Publication
(10) Pub. No.: US 2022/0005054 A1
(43) Pub. Date: Jan. 6, 2022

(54) INFORMATION PROCESSING APPARATUS, RECORDING MEDIUM, AND INFORMATION PROCESSING METHOD

(71) Applicant: TOYOTA JIDOSHA KABUSHIKI KAISHA, Tokyota-shi (JP)

(72) Inventors: Yurika TANAKA, Yokosuka-shi (JP); Shuichi SAWADA, Nagoya-shi (JP); Takaharu UENO, Nagoya-shi (JP); Shin SAKURADA, Toyota-shi (JP); Daiki YOKOYAMA, Gotemba-shi (JP); Genshi KUNO, Kasugai-shi (JP)

(73) Assignee: TOYOTA JIDOSHA KABUSHIKI KAISHA, Toyota-shi (JP)

(21) Appl. No.: 17/354,902

(22) Filed: Jun. 22, 2021

(30) Foreign Application Priority Data
Jul. 1, 2020 (JP) 2020-114056

(51) Int. Cl. G06Q 30/02; G06F 16/953

(52) U.S. Cl. CPC G06Q 30/0201; G06F 16/953

(57) ABSTRACT

A user terminal of a first user acquires a topic of a predetermined event occurring between the first user and a second user who is another user, detects a behavior, of the first user, on a web performed in relation to the topic, generates web behavior history information that is a history of the behavior, and transmits the web behavior history information of the first user. A server receives the web behavior history information of the first user, and transmits, to a user terminal of the second user, information indicating a degree of interest in the topic or the second user felt by the first user, the information being based on the web behavior history information of the first user.

### CROSS REFERENCE TO THE RELATED APPLICATION

This application claims the benefit of Japanese Patent Application No. 2020-114056, filed on Jul. 1, 2020, which is hereby incorporated by reference herein in its entirety.

### BACKGROUND

### Technical Field

The present disclosure relates to an information processing apparatus, a recording medium recorded with a program, and an information processing method.

### Description of the Related Art

There is disclosed extracting tasks regarding a user action plan, such as a trip, from a schedule database, and presenting search results related to the extracted tasks from a search site (for example, Patent document 1).

[Patent document 1] Japanese Patent Laid-Open No. 2008-269480

However, it is difficult to grasp whether another user related to the user action plan, such as a user who is to take part in the user action plan, is interested in the user action plan or how interested such other user is, for example.

An object of the present disclosure is to provide an information processing apparatus and a method that are capable of acquiring information indicating a degree of interest in a topic of a predetermined event felt by another user who participated in the event.

### SUMMARY

One aspect of the present disclosure is an information processing apparatus comprising a controller configured to:

acquire web behavior history information that is a history of behavior of a first user on a web performed through a user terminal of the first user, the behavior being about a topic of a predetermined event occurring between the first user and a second user, and

output information indicating a degree of interest in the topic or the second user felt by the first user, the information being based on the web behavior history information of the first user.

Another aspect of the present disclosure is a non-transitory computer-readable recording medium recorded with a program causing a computer to:

acquire a topic of a predetermined event occurring between a first user who is a user of the computer and a second user who is an other user;

detect a behavior, of the first user, on a web performed through the computer in relation to the topic;

acquire web behavior history information that is a history of the behavior; and

output information indicating a degree of interest in the topic or the first user felt by the second user, the information being based on the web behavior history information of the second user.

Another aspect of the present disclosure is an information processing method, comprising:

acquiring, by a user terminal of a first user, a topic of a predetermined event occurring between the first user and a second user who is an other user,

detecting, by the user terminal of the first user, a behavior, of the first user, on a web performed through the user terminal of the first user in relation to the topic,

generating, by the user terminal of the first user, web behavior history information that is a history of the behavior, and

transmitting, by the user terminal of the first user, the web behavior history information of the first user, and

receiving, by a server, the web behavior history information of the first user, and

transmitting, by the server, to a user terminal of the second user, information indicating a degree of interest in the topic or the second user felt by the first user, the information being based on the web behavior history information of the first user.

According to the present disclosure, information indicating a degree of interest in a topic of a predetermined event felt by another user who participated in the event may be acquired.

### BRIEF DESCRIPTION OF THE DRAWINGS

FIG. 1 is a diagram illustrating an example of a system configuration of a degree-of-interest determination system according to a first embodiment;

FIG. 2 is an example of hardware configurations of the center server and the user terminal;

FIG. 3 is a diagram illustrating an example of functional configurations of the center server and the user terminal;

FIG. 4 is a diagram illustrating an example of information that is stored in the topic information database of the user terminal;

FIG. 5 is a diagram illustrating an example of information that is stored in the web behavior history information database of the center server;

FIG. 6 is an example of a flowchart of the information gathering process by the user terminal;

FIG. 7 is an example of a flowchart of a degree-of-interest determination process by the center server; and

FIG. 8 is a diagram illustrating an example of a sequence of processes by the degree-of-interest determination system according to the first embodiment.

### DESCRIPTION OF THE EMBODIMENTS

An aspect of the present disclosure is an information processing apparatus. The information processing apparatus includes a controller. The controller of the information processing apparatus may configured to acquire web behavior history information that is a history of behavior of a first user on a web performed through a user terminal of the first user, the behavior being about a topic of a predetermined event occurring between the first user and a second user. Furthermore, the controller of the information processing apparatus may configured to output information indicating a degree of interest in the topic or the second user felt by the first user, the information being based on the web behavior history information of the first user.

The information processing apparatus is a server, for example. The controller is a processor such as a central processing unit (CPU), for example.

Another aspect of the present disclosure is a program. The program causes a computer corresponding to the user terminal to perform the following processes, for example. The processes include acquiring a topic of a predetermined event occurring between a first user who is a user of the computer and a second user who is an other user, detecting a behavior, of the first user, on a web performed through the computer in relation to the topic, acquiring web behavior history information that is a history of the behavior, and outputting information indicating a degree of interest in the topic or the first user felt by the second user, the information being based on the web behavior history information of the second user.

The predetermined event is registration of a schedule for which the first user and the second user are participants, for example. In this case, the program according to an aspect of the present disclosure may cause the computer to acquire a destination of the schedule as the topic.

The predetermined event is transmission or reception of a message between the first user and the second user, for example. In this case, the program according to an aspect of the present disclosure may cause the computer to acquire the topic from contents of the message.

The predetermined event is a non-face-to-face conversation between the first user and the second user, for example. In this case, the program according to an aspect of the present disclosure may cause the computer to acquire the topic from contents of the non-face-to-face conversation.

According to these aspects of the present disclosure, the degree of interest in a topic of a predetermined event or in oneself felt by another person who participated in the event may be acquired. Information indicating the degree of interest felt by a user may be information about a level among a plurality of levels each indicating the degree of interest, or may be the web behavior history information itself, for example.

The program according to an aspect of the present disclosure may cause the computer to detect, as a behavior of the first user on the web related to the topic, a behavior related to a first search that is a search for a web page performed with the topic as a keyword. Furthermore, the program may cause the computer to generate the web behavior history information of the first user including information about the behavior related to the first search.

According to an aspect of the present disclosure, in the case where the web behavior history information of the first user includes the information about the first search that is the search for a web page performed by the first user with the topic as the keyword, the information indicating the degree of interest felt by the first user may be as follows. For example, the information indicating the degree of interest felt by the first user may indicate a higher interest of the first user as the number of times of execution of the first search in a predetermined period of time from occurrence of the predetermined event is greater. For example, with respect to the degree of interest felt by the first user, the degree indicating the degree of interest felt by the first user may be determined to be higher as an elapsed time from occurrence of the predetermined event to first execution of the first search is shorter. For example, the information indicating the degree of interest felt by the first user may indicate a higher interest of the first user as the time spent by the first user on the first search is longer.

For example, in the case where the first user has a high interest in a topic, the number of times of search about the topic tends to increase, or a search tends to be performed soon after detection of the topic, or a search tends to be performed for a long period of time. Accordingly, the information indicating the degree of interest in a topic felt by the first user may be acquired based on the web behavior history information related to the first search that is performed by the first user with the topic as the keyword. Furthermore, in the case where the interest in the second user felt by the first user is high even though the interest in the topic is low, the first search that is performed by the first user with the topic as the keyword has the characteristics as described above. Accordingly, information indicating the degree of interest in the second user, who is the other person participated in the event for which the topic is detected, felt by the first user may be acquired based on the web behavior history information related to the first search that is performed by the first user with the topic as the keyword.

Additionally, the information processing apparatus according to an aspect of the present disclosure may be a user terminal, and in this case, the controller may be further configured to acquire the topic, detect a behavior of the first user related to the topic, and generate the web behavior history information of the first user.

Additionally, the program according to an aspect of the present disclosure may further cause the computer to output information indicating a degree of interest in the topic or the second user felt by the first user, based on the web behavior history information of the first user.

An information processing method may be specified as another aspect of the present disclosure. According to the information processing method, a user terminal of a first user acquires a topic of a predetermined event occurring between the first user and a second user who is an other user, detects a behavior, of the first user, on a web performed through the user terminal in relation to the topic, generates web behavior history information that is a history of the behavior, and transmits the web behavior history information of the first user. Furthermore, according to the information processing method, a server receives the web behavior history information of the first user, and transmits, to a user terminal of the second user, information indicating a degree of interest in the topic or the second user felt by the first user, the information being based on the web behavior history information of the first user.

In the following, an embodiment of the present disclosure will be described with reference to the drawings. The configuration of the embodiment described below is an example, and the present disclosure is not limited to the configuration of the embodiment.

### First Embodiment

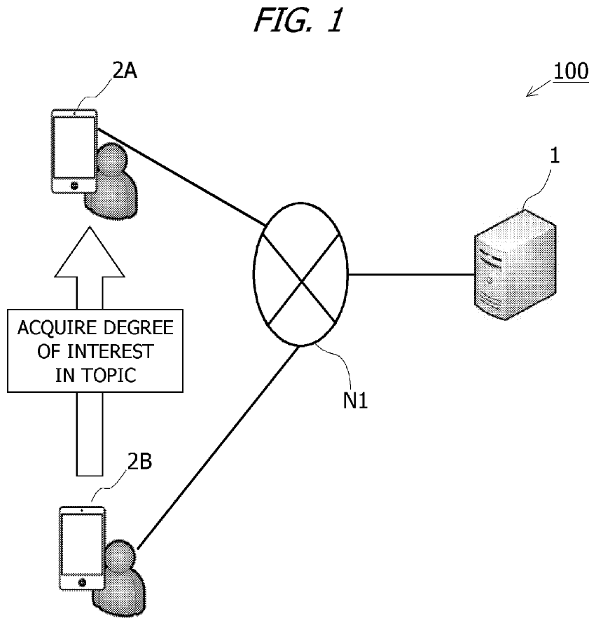

FIG. 1 is a diagram illustrating an example of a system configuration of a degree-of-interest determination system 100 according to a first embodiment. The degree-of-interest determination system 100 is a system that acquires the degree of interest, felt by a first user, in a topic of a predetermined event occurring between the first user and a second user or in the second user. For example, the degree-of-interest determination system 100 includes a center server 1, a user terminal 2A, and a user terminal 2B. However, the degree-of-interest determination system 100 may include a plurality of user terminals without being limited to the user terminal 2A and the user terminal 2B. In the following, when not distinguishing between the two, the user terminal 2A and the user terminal 2B will be simply referred to as “user terminal(s) 2”.

The center server 1, the user terminal 2A, and the user terminal 2B are each connected to a network N1, and are capable of communicating through the network N1. The network N1 is the Internet, for example.

An application of the degree-of-interest determination system 100 is installed in each user terminal 2. When a predetermined event occurs, the user terminal 2 extracts a topic from the event. The predetermined event is registration of a schedule, a non-face-to-face conversation, transmission or reception of a message, and the like, for example. The user terminal 2 monitors a behavior of the user on a web for a predetermined time length after occurrence of the predetermined event, and gathers, in relation to the topic, web behavior history information that is a history of behavior on the web. Behaviors on the web include search, browsing of a web page, and the like, for example. The user terminal 2 transmits the web behavior history information of the user to the center server 1.

The user terminal 2A is assumed to be a terminal that is used by a user A. The user terminal 2B is assumed to be a terminal that is used by a user B. For example, it is assumed that a topic X is extracted by each of the user terminal 2A and the user terminal 2B during a non-face-to-face conversation between the user A and the user B. The user terminal 2A and the user terminal 2B each transmits the web behavior history information of the user A or the user B to the center server 1 in relation to the topic X.

For example, the user terminal 2A transmits, to the center server 1, an acquisition request for the degree of interest in the topic X felt by the user B, in response to an operation input from the user A. Additionally, as a subject of the degree of interest felt by the user B, the user A may also be specified, in addition to the topic. When the acquisition request for the degree of interest in the topic X felt by the user B is received, the center server 1 determines the degree of interest in the topic X felt by the user B, based on the web behavior history information of the user B regarding the topic X. The user A, that is, a user who is a transmission source of the acquisition request for the degree of interest, is an example of “first user”. The user B, that is, a user who is the subject of the acquisition request for the degree of interest, is an example of “second user”. However, the users are not restrictive, a user who is the transmission source of the acquisition request for the degree of interest may also be an example of “second user”, and a user who is the subject of the acquisition request for the degree of interest may also be an example of “first user”. That is, when one of two users is “first user”, the other user is “second user”, and the terms “first user” and “second user” are used simply to distinguish between two users.

The degree of interest is determined based on the number of times of search about the topic X, the elapsed time from detection to search about the topic X, or the time spent on the search about the topic X, for example. For example, the degree of interest may be determined in stages, or may be determined in points where 100 is the maximum. After determining the degree of interest in the topic X felt by the user B, the center server 1 transmits the degree of interest to the user terminal 2A. The user terminal 2A outputs the degree of interest in the topic X felt by the user B that is received from the center server 1, and notifies the user A of the same. The degree of interest in the topic X felt by the user B is an example of “information indicating a degree of interest” in a topic felt by a user.

The user A may thus acquire the degree of interest in the topic X felt by the user B, and may grasp how interested the user B is in the topic X that was a subject of the non-face-to-face conversation. Moreover, by using the degree-of-interest determination system 100, the user A may acquire the degree of interest in a destination Y felt by the user B in a case where a schedule of visiting the destination Y with the user B is set, and may acquire the degree of interest felt by the user B in a movie that was a subject of messages exchanged with the user B, for example. Furthermore, the degree of interest in the user A felt by the user B may also be determined based on the web behavior history information of the user B regarding one or more topics.

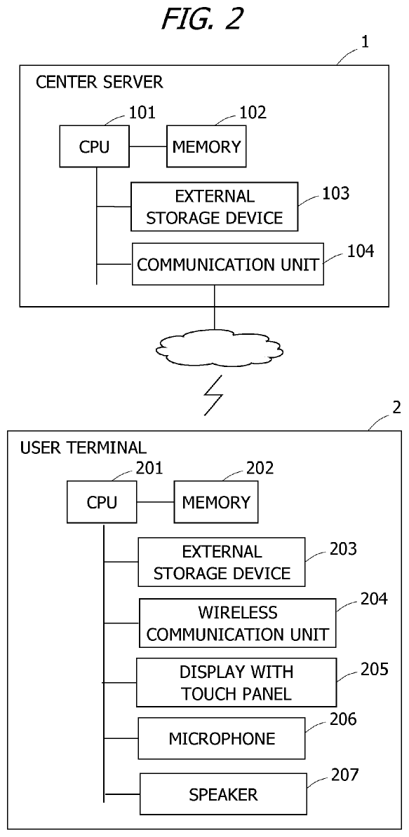

FIG. 2 is an example of hardware configurations of the center server 1 and the user terminal 2. As the hardware configuration, the center server 1 includes a CPU 101, a memory 102, an external storage device 103, and a communication unit 104. The memory 102 and the external storage device 103 are each a computer-readable recording medium. The center server 1 is an example of “information processing apparatus”.

The external storage device 103 stores various programs, and data to be used by the CPU 101 at the time of execution of each program. For example, the external storage device 103 is an erasable programmable ROM (EPROM) or a hard disk drive. Programs held in the external storage device 103 include an operating system (OS), a control program of the degree-of-interest determination system 100, and various other application programs, for example.

The memory 102 is a main memory that provides the CPU 101 with a storage area where the program stored in the external storage device 103 is to be loaded and a work area, and that is used as a buffer. The memory 102 includes semiconductor memories such as a read only memory (ROM) and a random access memory (RAM), for example.

The CPU 101 performs various processes by loading the OS and various application programs held in the external storage device 103 into the memory 102 and executing the same. The number of CPUs 101 may be one or more. The CPU 101 is an example of “controller”.

The communication unit 104 is a wired network card for a local area network (LAN), a dedicated line, and the like, for example, and the communication unit 104 connects to the network N1 through an access network such as the LAN. The hardware configuration of the center server 1 is not limited to the one illustrated in FIG. 2.

As the hardware configuration, the user terminal 2 includes a CPU 201, a memory 202, an external storage device 203, a wireless communication unit 204, a display 205 with a touch panel, and a microphone 206, for example. However, FIG. 2 extracts and illustrates hardware related to the degree-of-interest determination system 100, and the hardware configuration of the user terminal 2 is not limited to the one illustrated in FIG. 2.

The CPU 201, the memory 202, and the external storage device 203 are the same as the CPU 101, the memory 102, and the external storage device 103, respectively, and a description thereof is omitted. An application for a client of the degree-of-interest determination system 100 is stored in the external storage device 203.

The wireless communication unit 204 is a wireless communication circuit compatible with 5th generation (5G), long term evolution (LTE), LTE-Advanced, 3rd generation (3G), and the like mobile communication methods or with a wireless communication method such as WiFi, for example. The wireless communication unit 204 connects to an access network through wireless communication, and connects to the network N1 through the access network.

The display 205 with a touch panel and the microphone 206 are examples of an input device. A user operation is input to the display 205 with a touch panel or the microphone 206. Furthermore, the display 205 with a touch panel is an example of an output device, and outputs the degree of interest felt by a subject user, for example. The user terminal 2 may, in addition, include a speaker 207 as an example of the output device.

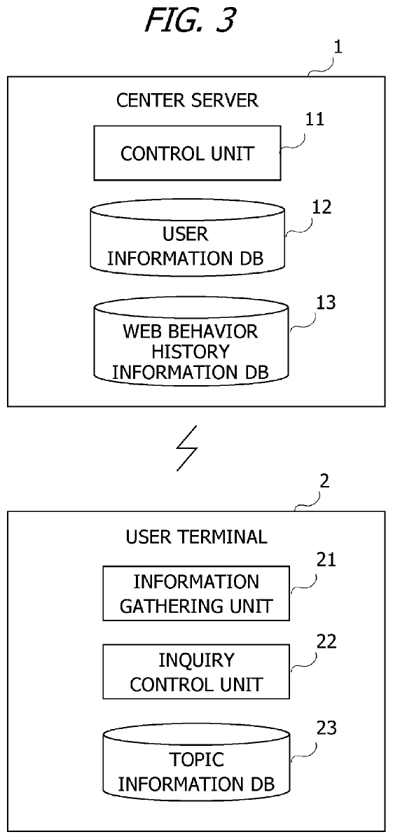

FIG. 3 is a diagram illustrating an example of functional configurations of the center server 1 and the user terminal 2. As the functional configuration, the user terminal 2 includes an information gathering unit 21, an inquiry control unit 22, and a topic information database (DB) 23. These functional elements are implemented by the CPU 201 of the user terminal 2 executing the application for a client of the degree-of-interest determination system 100, for example.

In a case where a start condition is satisfied, the information gathering unit 21 starts an information gathering process of gathering the web behavior history information. Furthermore, in a case where an end condition is satisfied, the information gathering unit 21 ends the information gathering process. For example, the start condition for the information gathering process is occurrence of a predetermined event in which a user of the user terminal 2 and another user are participants. A predetermined event in which the user of the user terminal 2 and another user are participants may be a non-face-to-face conversation between the two users, transmission and reception of messages, registration of a schedule for which the two users are participants, and the like, for example.

The information gathering unit 21 detects occurrence of such an event by monitoring an operation of a coordinating application, for example. A coordinating application is an application including at least one function among functions related to non-face-to-face conversation, exchange of messages, and schedule management, for example. Specifically, targeted applications for coordination with the degree-of-interest determination system 100 include a non-face-to-face conversation application, a message exchange application, a social networking system (SNS) application including a non-face-to-face conversation or message exchange function, a game application including a non-face-to-face conversation or message exchange function, a schedule management application, and the like.

The end condition for the information gathering process is lapse of a predetermined time length or end of a predetermined period of time, from occurrence of a predetermined event, for example. The predetermined time length from occurrence of a predetermined event that is adopted as the end condition may be arbitrarily set in units of one day, one week, or one month, for example. In the case where the predetermined event is registration of a schedule, the predetermined period of time from occurrence of the predetermined event that is adopted as the end condition is up to a start time of the schedule, for example. The end condition may be set according to a predetermined event that satisfies the start condition, for example.

In the information gathering process, the information gathering unit 21 performs detection of a topic from the predetermined event, monitoring of a web behavior of the user regarding the detected topic, generation of the web behavior history information, and transmission of the web behavior history information to the center server 1, for example.

Details of detection of a topic from a predetermined event are as follows, for example. A method of detecting a topic changes according to contents of the predetermined event, for example. In the case where the predetermined event is a non-face-to-face conversation, for example, the information gathering unit 21 detects the topic from the contents of the non-face-to-face conversation. In the case where the predetermined event is transmission or reception of a message, for example, the information gathering unit 21 detects the topic from the message. In the case where the predetermined event is registration of a schedule, for example, the information gathering unit 21 detects a destination of the registered schedule as the topic.

The topic may also be referred to as a conversation topic, a main subject, a theme, material, a keyword, or the like. The topic is a proper noun, and may be a point of interest (POI), a person's name, the name of a place, the title of a movie, and the like, for example. The information gathering unit 21 may acquire the topic from audio data and text data by using a predetermined model or engine, for example. The method of detecting a topic from audio data and text data is not limited to a particular method, and any of a method that uses a learning model and existing techniques may be used, for example.

In the case where the predetermined event is a non-face-to-face conversation or transmission or reception of a message, a proper noun that is included in a sentence, together with a phrase suggesting a future event in which the two users are to participate, may be detected as the topic, for example. A future action in which the two users are to participate may be a visit, viewing, a joint activity, feeding back, or the like, for example. A phrase suggesting a future action in which the two users are to participate may be a phrase encouraging participation, such as “want to go?” or “let's go”, and a phrase asking for comments, such as “tell me” or “any thoughts?”, for example.

The information gathering unit 21 stores information about a detected topic in the topic information DB 23 described later. In the topic information DB 23, a topic and user identification information of a user who participated in an event for which the topic is detected are associated with each other. One or more topics may be acquired from a predetermined event. Detection of topics is ended when the predetermined event is ended.

Details of monitoring of a web behavior of a user regarding a detected topic are as follows, for example. Web behaviors that are subjects of monitoring are a search for a web page, browsing of the web page, and end of search that are performed in relation to the detected topic, for example. The information gathering unit 21 operates in conjunction with a browser and acquires access history information about web pages from the browser to thereby detect occurrence of a search for a web page, browsing and end in relation to the detected topic, for example.

Details of generation of the web behavior history information are as follows, for example. When a web behavior, of the user, that is a subject of monitoring is detected, the information gathering unit 21 generates the web behavior history information. The web behavior history information includes user identification information, an occurrence time, a behavior type, the uniform resource locator (URL) of a web page, a topic, user identification information of a participant user of an event for which the topic is detected, and identification information of an application where the event for which the topic is detected occurred, for example. Of these, the URL of a web page, the topic, the user identification information of a participant user of an event, and the identification information of an application where the event for which the topic is detected occurred are included depending on the behavior type.

The user identification information is identification information of a user that is used by the degree-of-interest determination system 100. The identification information of a user that is used by the degree-of-interest determination system 100 is user identification information that is assigned by the degree-of-interest determination system 100 or user identification information that is assigned in relation to a service that is available in conjunction with the degree-of-interest determination system 100, for example. Which user identification information is to be used is selected by the user at the time of user registration with the degree-of-interest determination system 100, for example. Furthermore, association in the center server 1 is performed such that, in the case where the identification information of a user that is used by the degree-of-interest determination system 100 and the identification information of a user that is used by a service that is used in conjunction with the degree-of-interest determination system 100 are different, the information pieces are recognized to indicate the same user, for example.

The behavior types included in the web behavior history information may be “search”, “browse”, and “end of search”, for example. Additionally, the behavior types in the web behavior history information are not limited to those listed above.

For example, in the case where a search query is included in an URL included in the access history information that is acquired from a browser, and a keyword for the search includes a topic, the information gathering unit 21 detects a search for a web page that is related to the topic that is detected. In this case, the information gathering unit 21 generates the web behavior history information for which the behavior type is “search”. The web behavior history information for which the behavior type is “search” includes the URL of the web page, the topic, the user identification information of the participant user of the event, and the identification information of the application where the event for which the topic is detected occurred.

For example, in the case where, after a search for a web page that is related to the detected topic is detected, there is occurrence of an access to the web page in a state where the session is still established, the information gathering unit 21 detects browsing of the web page that is related to the detected topic. In this case, the information gathering unit 21 generates the web behavior history information for which the behavior type is “browse”. The web behavior history information for which the behavior type is “browse” includes, for example, the URL of the web page, but does not include the topic, the user identification information of the participant user of the event, and the identification information of the application where the event for which the topic is detected occurred.

For example, in the case where, after a search for a web page that is related to the detected topic is detected, there is occurrence of a search in relation to a keyword not including the detected topic in a state where the session is still established and the browser is ended, the information gathering unit 21 detects end of search for a web page that is related to the detected topic. In this case, the information gathering unit 21 generates the web behavior history information for which the behavior type is “end of search”. The web behavior history information for which the behavior type is “end of search” does not include any of the URL of the web page, the topic, the user identification information of the participant user of the event, and the identification information of the application where the event for which the topic is detected occurred, for example.

Details of transmission of the web behavior history information to the center server 1 are as follows. In the first embodiment, after generating the web behavior history information, the information gathering unit 21 transmits the generated web behavior history information to the center server 1. However, such a case is not restrictive, and the information gathering unit 21 may store the web behavior history information in a predetermined area in the external storage device 203 after generating the information, and may collectively transmit the web behavior history information stored in the predetermined area in the external storage device 203 at a predetermined timing, for example. The timing of collectively transmitting the web behavior history information is when end of search is detected or when an acquisition request for the web behavior history information is received from the center server 1, for example. Furthermore, the web behavior history information transmitted to the center server 1 may be deleted from the predetermined area in the external storage device 203.

The inquiry control unit 22 controls inquiry about the degree of interest in a subject item felt by a subject user. Specifically, the inquiry control unit 22 receives a user operation for inquiry about the degree of interest, input through the input device such as the display 205 with a touch panel. With the user operation for inquiry about the degree of interest, the identification information of the subject user and the subject item are input, for example. As the subject item, there may be the user of the user terminal 2 and the topic. In the case where the subject item is the topic, the topic specified by the user is also input.

When the user operation for inquiry about the degree of interest is received, the inquiry control unit 22 transmits an acquisition request for the degree of interest to the center server 1. For example, together with the acquisition request for the degree of interest, the user identification information of the user terminal 2, the user identification information of the subject user, information indicating the subject item, text data indicating a specified topic in the case where the subject item is a topic, and a detection time of a topic corresponding to the subject user or the specified topic are also transmitted to the center server 1. The inquiry control unit 22 receives the degree of interest in the subject item felt by the subject user, from the center server 1 as a response to the acquisition request for the degree of interest. The inquiry control unit 22 outputs the received degree of interest to the display 205 with a touch panel, for example.

The topic information DB 23 is a database that stores information about a topic extracted from a predetermined event. The topic information DB 23 is created in a predetermined storage area in the external storage device 203 of the user terminal 2. Details of information that is stored in the topic information DB 23 will be given later.

As the functional configuration, the center server 1 includes a control unit 11, a user information DB 12, and a web behavior history information DB 13. These functional elements are implemented by the CPU 101 of the center server 1 executing the control program of the degree-of-interest determination system 100, for example.

The control unit 11 receives the web behavior history information from the user terminal 2. The control unit 11 stores the web behavior history information received from the user terminal 2, in the web behavior history information DB 13.

Furthermore, the control unit 11 receives an acquisition request for the degree of interest from the user terminal 2. For example, together with the acquisition request for the degree of interest, the user identification information of the user terminal 2 that is the transmission source, the user identification information of the subject user, information indicating the subject item, text data indicating a specified topic in the case where the subject item is a topic, and a detection time of a topic corresponding to the subject user or the specified topic are also received from the user terminal 2.

When the acquisition request for the degree of interest is received from the user terminal 2, the control unit 11 extracts the web behavior history information of the subject user from the web behavior history information DB 13. The control unit 11 determines the degree of interest in the subject item felt by the subject user, based on the extracted web behavior history information. Determination of the degree of interest is performed based on at least one of the number of times of search and the total amount of time spent on the search about the subject item, for example. The control unit 11 determines the degree of interest in the subject item to be higher as the number of times of search about the subject item is greater, for example. The degree of interest in the subject item is determined to be higher as the total amount of time spent on the search about the subject item is longer.

Elements used in determining the degree of interest are not limited to the number of times of search and the time spent on the search, and an elapsed time from detection of the topic to start of the search, an average value of depths of searches, and the like may also be used, for example. The depth of a search is the number of web pages browsed following a page displaying search results, or in other words, the depth of a search is the number of web pages browsed from when a search is performed with one keyword until a search is performed with a different keyword in one session of the browser, for example. For example, the control unit 11 determines the degree of interest in the subject item to be higher as the elapsed time from detection of the topic to start of the search is shorter. For example, the control unit 11 determines the degree of interest in the subject item to be higher as the average value of the depths of searches is greater.

For example, the degree of interest may be evaluated in five stages or in percentage. Furthermore, in the case where a plurality of elements are used to determine the degree of interest, evaluation may be performed by performing evaluation for each element and weighting each element. Furthermore, in the case where the degree of interest is evaluated in a plurality of levels, conditions may be set for each level based on the number of times of search, the time spent on the search, the elapsed time from detection of the topic to start of the search, and the average value of the depths of searches, and a level satisfying the conditions may be acquired as the degree of interest, for example. The control unit 11 transmits the degree of interest acquired as the determination result to the user terminal 2 that is the transmission source of the acquisition request for the degree of interest.

The user information DB 12 and the web behavior history information DB 13 are created in a predetermined storage area in the external storage device 103 of the center server 1. The user information DB 12 holds information about a user who is registered as a user with the degree-of-interest determination system 100. For example, the user information DB 12 stores association between user identification information used by the degree-of-interest determination system 100 and user identification information of the user in question that is used by a service that is used in conjunction with the degree-of-interest determination system 100. In the case where a plurality of services are used in conjunction with the degree-of-interest determination system 100, and each service uses different user identification information, the user identification information used by each service is associated in the user information DB 12.

The web behavior history information DB 13 stores the web behavior history information that is received from the user terminal 2. Details of the information that is held in the web behavior history information DB 13 will be given later.

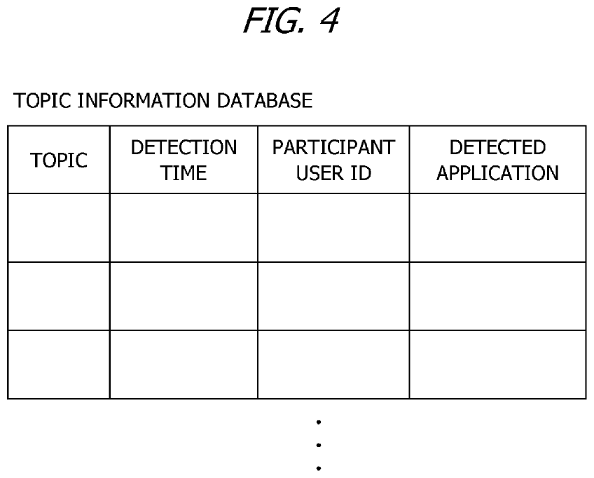

FIG. 4 is a diagram illustrating an example of information that is stored in the topic information DB 23 of the user terminal 2. One entry in the topic information DB 23 corresponds to one topic information piece. An entry in the topic information DB 23 includes the following fields: topic, detection time, participant user ID, and detected application.

A word indicating a topic that is detected in relation to a predetermined event is stored in the field “topic”. A date/time when the topic is detected is stored in the field “detection time”. The user identification information of a user who participated in the predetermined event for which the topic is detected and who is other than the user of the user terminal 2 is stored in the field “participant user ID”. The identification information of an application where the predetermined event for which the topic is detected occurred is stored in the field “detected application”.

The user identification information that is stored in the field “participant user ID” is identification information that is used, in a service of the application that is indicated by the value in the field “detected application”, by another user who participated in the predetermined event for which the topic is detected, for example.

The entry in the topic information DB 23 may be deleted after a lapse of a predetermined period of time from registration, for example. Additionally, information pieces to be stored in the topic information DB 23 are not limited to the information pieces illustrated in FIG. 4.

The topic information DB 23 is used to identify the topic that is to be the subject of monitoring, at the time of monitoring of the web behavior of the user by the information gathering unit 21 of the user terminal 2. Moreover, in the first embodiment, in the case where a web behavior is detected, the topic information of the corresponding topic is transmitted to the center server 1 by being included in the web behavior history information.

Furthermore, the topic information DB 23 is also used at the time of transmission of the acquisition request for the degree of interest. One of information pieces that are transmitted together with the acquisition request for the degree of interest is the detection time of the topic corresponding to the subject user or a specified topic. In the case where the subject item is a topic, the inquiry control unit 22 acquires the value in the field “detection time” in an entry in the topic information DB 23, matching the topic and the subject user, as the detection time to be transmitted together with the acquisition request for the degree of interest. This entry is an entry where the value in the field “topic” corresponds to the specified topic, and the value in the field “participant user ID” corresponds to the user identification information of the subject user.

In the case where the subject item is the user himself/herself, the inquiry control unit 22 acquires, from entries in the topic information DB 23, matching the subject user, the detection time of an entry where the value in the field “detection time” indicates an earliest date/time, as the detection time to be transmitted together with the acquisition request for the degree of interest. This entry is an entry where the value in the field “participant user ID” corresponds to the user identification information of the subject user.

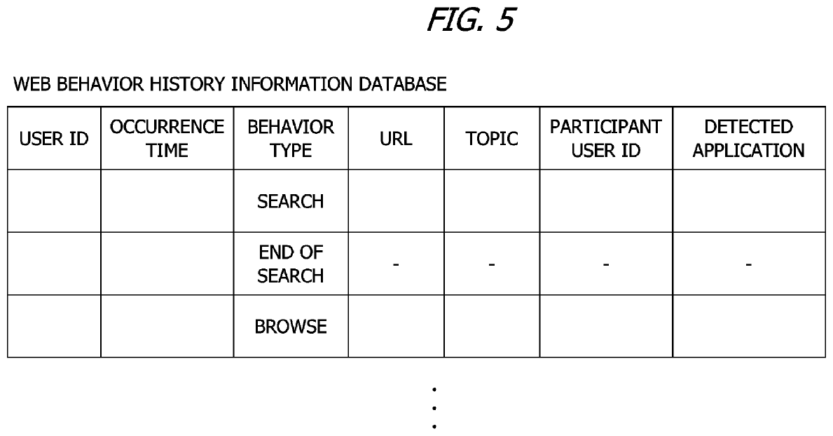

FIG. 5 is a diagram illustrating an example of information that is stored in the web behavior history information DB 13 of the center server 1. One entry in the web behavior history information DB 13 corresponds to one web behavior history information piece that is received from the user terminal 2. An entry of the web behavior history information includes the following fields: user ID, occurrence time, behavior type, URL, topic, participant user ID, and detected application.

The user identification information that the user of the user terminal 2 that generated the web behavior history information is using in association with the degree-of-interest determination system 100 is stored in the field “user ID”. The date/time of occurrence of the web behavior corresponding to the web behavior history information is stored in the field “occurrence time”. The type of the web behavior corresponding to the web behavior history information is stored in the field “behavior type”. In the first embodiment, the type of the web behavior is one of “search”, “end of search”, or “browse”. The URL of a web page that is accessed by the user terminal 2, according to the web behavior history information, is stored in the field “URL”.

A word corresponding to a topic that is searched by the web behavior corresponding to the web behavior history information is stored in the field “topic”. The identification information of a user who participated in the event for which the topic indicated by the value that is stored in the field “topic” is detected and who is other than the user indicated by the value that is stored in the field “user ID” is stored in the field “participant user ID”. The identification information of an application where the event for which the topic indicated by the value that is stored in the field “topic” is detected occurred, the event occurring in the user terminal 2 that generated the web behavior history information, is stored in “detected application”.

Values are stored in the fields “user ID”, “occurrence time”, and “behavior type”, regardless of the type of the web behavior. For example, in the case where the type of the web behavior is “search”, values are stored in the fields “URL”, “topic”, “participant user ID”, and “detected application”. The URL that is stored in the field “URL” in the case where the type of the web behavior is “search” is the URL of a web page displaying search results. For example, in the case where the type of the web behavior is “browse”, a value is stored in the field “URL” but not in the fields “topic”, “participant user ID”, and “detected application”. For example, in the case where the type of the web behavior is “end of search”, no value is stored in the fields “URL”, “topic”, “participant user ID”, and “detected application”.

The entry in the web behavior history information DB 13 may be deleted after a lapse of a predetermined period of time from registration, for example. Additionally, information pieces to be stored in the web behavior history information DB 13 are not limited to the information pieces illustrated in FIG. 5.

The number of times of search by one user on the web is determined by counting the number of web behavior history information pieces for which the behavior type is “search”, among the web behavior history information pieces that are used to determine the degree of interest felt by the user, for example. The time spent by one user to search about one topic is determined based on a time length from an occurrence time of web behavior history information for which the behavior type is “search” to an occurrence time of web behavior history information for which the behavior type for another topic is “search” or for which the behavior type is “end of search”, for example.

The elapsed time from detection of a topic to start of search, regarding one user, is determined based on a time length from the detection time of the topic to a first occurrence time, after the detection time, of web behavior history information regarding the topic, for which the behavior type is “search”. The detection time of a topic is acquired from the user terminal 2, together with the acquisition request for the degree of interest, for example.

The depth of a search by one user about one topic is determined based on the number of web behavior history information pieces for which the behavior type is “browse”, included between an occurrence time of the web behavior history information, regarding the topic, for which the behavior type is “search” and an occurrence time of the web behavior history information for which the behavior type for another topic is “search” or for which the behavior type is “end of search”, for example.

<Flow of Processes>

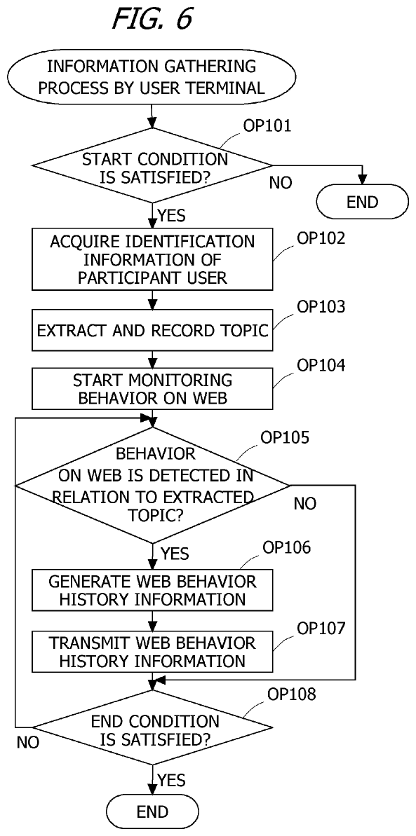

FIG. 6 is an example of a flowchart of the information gathering process by the user terminal 2. The information gathering process illustrated in FIG. 6 is repeated every predetermined period of time. Additionally, the performer of the processes illustrated in FIG. 6 is the CPU 201 of the user terminal 2, but a description will be given taking a functional element as the performer for the sake of convenience.

In OP101, the information gathering unit 21 determines whether the start condition is satisfied. The start condition for the information gathering process is occurrence of a predetermined event in which the user of the user terminal 2 and another user are participants, for example. In the case where the start condition is satisfied (OP101: YES), the process proceeds to OP102. In the case where the start condition is not satisfied (OP101: NO), the process illustrated in FIG. 6 is ended.

In OP102, the information gathering unit 21 acquires the user identification information of the participant user of the predetermined event. For example, in the case where the predetermined event is a non-face-to-face conversation, the participant user is the other party of the non-face-to-face conversation. For example, in the case where the predetermined event is transmission or reception of a message, the participant user is the user who is the destination or the transmission source of the message. For example, in the case where the predetermined event is registration of a schedule, the participant user is a user who is to participate in the schedule.

In OP103, the information gathering unit 21 extracts a topic from the predetermined event, and records the same in the topic information DB 23. The number of topics to be extracted may be one or more. In OP104, the information gathering unit 21 starts monitoring behavior on the web.

In OP105, the information gathering unit 21 determines whether a behavior on the web is detected in relation to the topic extracted in OP103. In the case where a behavior on the web is detected in relation to the topic extracted in OP103 (OP105: YES), the process proceeds to OP106. In the case where a behavior on the web is not detected in relation to the topic extracted in OP103 (OP105: NO), the process proceeds to OP108.

In OP106, the information gathering unit 21 generates the web behavior history information. In OP107, the information gathering unit 21 transmits the generated web behavior history information to the center server 1.

In OP108, the information gathering unit 21 determines whether the end condition is satisfied. In the case where the end condition is satisfied (OP108: YES), the process illustrated in FIG. 6 is ended. In the case where the end condition is not satisfied (OP108: NO), the process proceeds to OP105.

The information gathering process by the user terminal 2 is not limited to the process illustrated in FIG. 6. In FIG. 6, the web behavior history information is transmitted to the center server 1 at the timing of generation, but the transmission timing of the web behavior history information to the center server 1 is not limited thereto. For example, web behavior history information pieces for a predetermined period of time may be collectively transmitted to the center server 1, or transmission may be performed in response to a request from the center server 1.

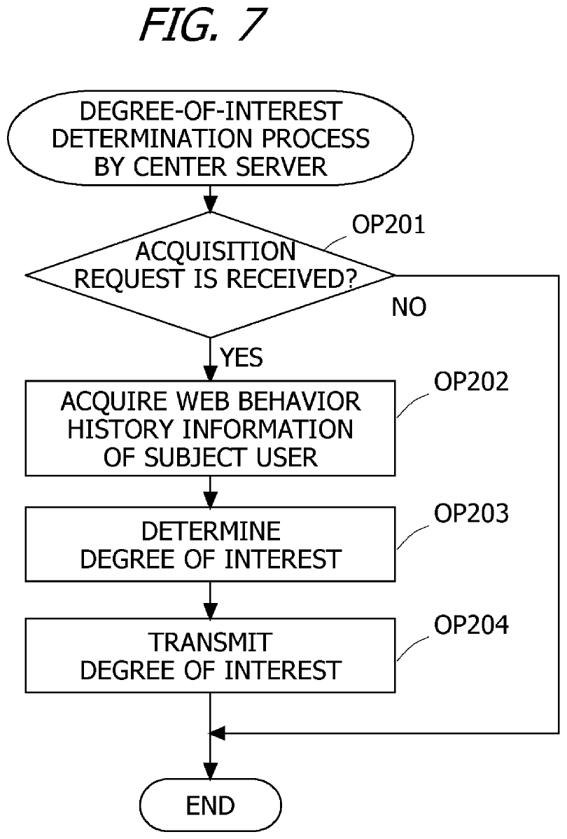

FIG. 7 is an example of a flowchart of a degree-of-interest determination process by the center server 1. The process illustrated in FIG. 7 is repeated every predetermined period of time. Additionally, the performer of the processes illustrated in FIG. 7 is the CPU 101 of the center server 1, but a description will be given taking a functional element as the performer for the sake of convenience.

In OP201, the control unit 11 determines whether an acquisition request for the degree of interest is received from the user terminal 2. In the case where an acquisition request for the degree of interest is received from the user terminal 2 (OP201: YES), the process proceeds to OP202. In the case where an acquisition request for the degree of interest is not received from the user terminal 2 (OP202: NO), the process illustrated in FIG. 7 is ended.

In OP202, the control unit 11 acquires the web behavior history information of the subject user from the web behavior history information DB 13. The web behavior history information that is acquired is the web behavior history information, the occurrence time of which is after the detection time that is received together with the acquisition request for the degree of interest, for example. Furthermore, in the case where the subject item of the acquisition request for the degree of interest is the topic, the web behavior history information for the specified topic is further extracted.

In OP203, the control unit 11 determines the degree of interest. In OP204, the control unit 11 transmits the degree of interest to the user terminal 2 that is the transmission source of the acquisition request for the degree of interest. The process illustrated in FIG. 7 is then ended.

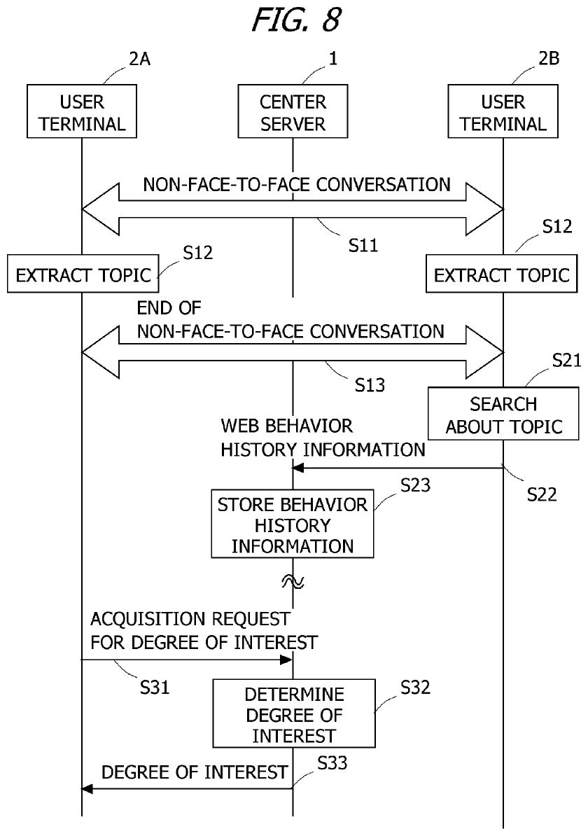

FIG. 8 is a diagram illustrating an example of a sequence of processes by the degree-of-interest determination system 100 according to the first embodiment. FIG. 8 illustrates an example where the degree of interest in a topic X of a non-face-to-face conversation between the user A and the user B, felt by the user B, is acquired. The user A uses the user terminal 2A. The user B uses the user terminal 2B. The user A and the user B are registered as users with the degree-of-interest determination system 100, and a client application of the degree-of-interest determination system 100 is installed in the user terminal 2A and the user terminal 2B.

In S11, a non-face-to-face conversation takes place between the user A and the user B. The user terminal 2A and the user terminal 2B detect that the start condition for the information gathering process is satisfied (FIG. 6, OP101: YES). In S12, the user terminal 2A and the user terminal 2B extract the topic X from the contents of the non-face-to-face conversation between the user A and the user B. The user terminal 2A and the user terminal 2B each generates topic information that takes the topic X as “topic” and the user identification information of the user B or the user A as “participant user ID”, and store the information in the topic information DB 23 (FIG. 6, OP102, OP103). Furthermore, the user terminal 2A and the user terminal 2B start monitoring of the web behavior of the user A or the user B (FIG. 6, OP104). In S13, the non-face-to-face conversation between the user A and the user B is ended.

In S21, the user B searches about the topic X using the user terminal 2B, and the user terminal 2B detects the web behavior (FIG. 6, OP105: YES). In S22, the user terminal 2B generates, in relation to the topic X, web behavior history information for which the behavior type is “search” (FIG. 6, OP106), and transmits the information to the center server 1 (FIG. 6, OP107). In S23, the center server 1 receives the web behavior history information from the user terminal 2B, and stores the information in the web behavior history information DB 13. Thereafter, when search, browsing of a web page, and end of search are detected by the user terminal 2B in relation to the topic X, web behavior history information is generated and transmitted to the center server 1.

In S31, the user terminal A transmits, to the center server 1, an acquisition request for the degree of interest in the topic X felt by the user B according to input an operation from user A. The center server 1 receives the acquisition request for the degree of interest from the user terminal 2A (FIG. 7, OP201: YES). In S32, the center server 1 acquires the web behavior history information of the user B regarding the topic X from the web behavior history information DB 13 (FIG. 7, OP202), and determines, based on the information, the degree of interest in the topic X felt by the user B (FIG. 7, OP203). In S33, the center server 1 transmits the degree of interest that is determined to the user terminal 2A (FIG. 7, OP204). The user terminal 2A outputs the degree of interest received from the center server 1 on the display 205 with a touch panel, for example.

<Effects of First Embodiment>

In the first embodiment, the degree of interest in a topic of a predetermined event occurring between two users or in one of the users, felt by the other user, may be acquired based on the web behavior history information of the other user. Accordingly, for example, in the case where a schedule for the user A and the user B to visit a destination Z together is registered, the user A may grasp the degree of interest in the destination Z felt by the user B. For example, if the degree of interest in the destination Z felt by the user B is lower than the user A expected, the user A may propose another destination to the user B.

Furthermore, according to the first embodiment, in the case where the user A and the user B are users who are registered on a dating application, and a non-face-to-face conversation or exchange of messages is performed several times between the user A and the user B, the user A may grasp the degree of interest in the user A felt by the user B, for example. For example, if the degree of interest in the user A felt by the user B is higher than the user A expected, the user A may make further approaches to the user B, such as by proposing to meet in person.

As described above, by enabling acquisition of the degree of interest in a topic of a predetermined event occurring between two users or in one of the users, felt by the other user, at least one of the users may be supported in determining the next step to take.

<Other Embodiments>

The embodiment described above is an example, and the present disclosure may be changed and carried out as appropriate without departing from the gist of the present disclosure.

In the first embodiment, an example of occurrence of an event between two users is described, but the number of users who are to participate in an event is not limited to two and may be three or more.

In the first embodiment, the center server 1 collects the web behavior history information of each user and determines the degree of interest felt by a subject user, but the determination of the degree of interest is not limited to be performed in such a manner. Determination of the degree of interest may be performed by the user terminal 2 of the subject user. In this case, the user terminal 2 does not transmit the web behavior history information to the center server 1, and the center server 1 simply relays the acquisition request for the degree of interest and a notification about the degree of interest. In the case where the user terminal 2 determines the degree of interest felt by the user, the web behavior history information of the user is not output to outside, and an infringement of privacy may be prevented.

In the first embodiment, the degree of interest felt by a subject user is determined and output based on the web behavior history information of the subject user. Alternatively, the web behavior history information itself of the subject user may be output. For example, the fact that the subject user performs a web search about a topic indicates that the subject user is interested in the topic. Accordingly, the degree of interest in the topic felt by the subject user may be indicated by presenting the web behavior history information itself of the subject user. In this case, the web behavior history information is an example of “information indicating a degree of interest”.

Processes and means described in the present disclosure may be freely combined to the extent that no technical conflict occurs.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a controller configured to:
acquire web behavior history information that is a history of behavior of a first user on a web performed through a user terminal of the first user, the behavior being about a topic of a predetermined event occurring between the first user and a second user, and
output information indicating a degree of interest in the topic or the second user felt by the first user, the information being based on the web behavior history information of the first user.

2. The information processing apparatus according to claim 1, wherein
the web behavior history information of the first user is information about a first search that is a search for a web page performed by the first user with the topic as a keyword, and
the information indicating the degree of interest felt by the first user indicates that the degree of interest felt by the first user is higher as the number of times of execution of the first search in a predetermined period of time from occurrence of the predetermined event is greater.

3. The information processing apparatus according to claim 1, wherein
the web behavior history information of the first user includes information about a first search that is a search for a web page performed by the first user with the topic as a keyword, and
the information indicating the degree of interest felt by the first user indicates that interest felt by the first user is higher as an elapsed time from occurrence of the predetermined event to first execution of the first search is shorter.

4. The information processing apparatus according to claim 1, wherein
the web behavior history information of the first user includes information about a first search that is a search for a web page performed by the first user with the topic as a keyword, and
the information indicating the degree of interest felt by the first user indicates that interest felt by the first user is higher as a time spent by the first user on the first search is longer.

5. The information processing apparatus according to claim 1, wherein the controller is configured to transmit the information indicating the degree of interest felt by the first user, in response to reception of an acquisition request for the degree of interest felt by the first user.

6. The information processing apparatus according to claim 1, wherein the controller is further configured to:
acquire the topic,
detect a behavior, on the web, of the first user performed through the user terminal of the first user in relation to the topic, and
generate the web behavior history information.

7. A non-transitory computer-readable recording medium recorded with a program causing a computer to:
acquire a topic of a predetermined event occurring between a first user who is a user of the computer and a second user who is an other user;
detect a behavior, of the first user, on a web performed through the computer in relation to the topic;
acquire web behavior history information that is a history of the behavior; and
output information indicating a degree of interest in the topic or the first user felt by the second user, the information being based on the web behavior history information of the second user.

8. The non-transitory computer-readable recording medium recorded with the program according to claim 7, wherein
the predetermined event is registration of a schedule for which the second user is a participant, and
the program causes the computer to acquire a destination of the schedule as the topic.

9. The non-transitory computer-readable recording medium recorded with the program according to claim 7, wherein
the predetermined event is reception of a message from the second user or transmission of the message to the second user, and
the program causes the computer to acquire the topic from contents of the message that is received or transmitted.

10. The non-transitory computer-readable recording medium recorded with the program according to claim 7, wherein
the predetermined event is a non-face-to-face conversation with the second user, and
the program causes the computer to acquire the topic from contents of the non-face-to-face conversation.

11. The non-transitory computer-readable recording medium recorded with the program according to claim 7, the program causing the computer to:
detect, as a behavior of the first user on the web related to the topic, a behavior related to a first search that is a search for a web page performed with the topic as a keyword, and
generate the web behavior history information of the first user including information about the behavior related to the first search.

12. The non-transitory computer-readable recording medium recorded with the program according to claim 11, wherein the behavior related to the first search includes execution of the first search, end of the first search, and browsing of a web page.

13. The non-transitory computer-readable recording medium recorded with the program according to claim 7, for the program further causing the computer to output information indicating a degree of interest in the topic or the second user felt by the first user, the information being based on the web behavior history information of the first user.

14. An information processing method, comprising:
acquiring, by a user terminal of a first user, a topic of a predetermined event occurring between the first user and a second user who is an other user,
detecting, by the user terminal of the first user, a behavior, of the first user, on a web performed through the user terminal of the first user in relation to the topic,
generating, by the user terminal of the first user, web behavior history information that is a history of the behavior, and
transmitting, by the user terminal of the first user, the web behavior history information of the first user, and
receiving, by a server, the web behavior history information of the first user, and
transmitting, by the server, to a user terminal of the second user, information indicating a degree of interest in the topic or the second user felt by the first user, the information being based on the web behavior history information of the first user.

15. The information processing method according to claim 14, wherein
the predetermined event is registration of a schedule for which the second user is a participant, and
the user terminal of the first user acquires a destination of the schedule as the topic.

16. The information processing method according to claim 14, wherein
the predetermined event is reception of a message from the second user or transmission of the message to the second user, and
the user terminal of the first user acquires the topic from contents of the message that is received or transmitted.

17. The information processing method according to claim 14, wherein
the predetermined event is a non-face-to-face conversation with the second user, and
the user terminal of the first user acquires the topic from contents of the non-face-to-face conversation.

18. The information processing method according to claim 14, wherein
the web behavior history information of the first user is information about a first search that is a search for a web page performed by the first user with the topic as a keyword, and
the information indicating the degree of interest felt by the first user indicates that interest felt by the first user is higher as the number of times of execution of the first search in a predetermined period of time from occurrence of the predetermined event is greater.

19. The information processing method according to claim 14, wherein
the web behavior history information of the first user includes information about a first search that is a search for a web page performed by the first user with the topic as a keyword, and
the information indicating the degree of interest felt by the first user indicates that interest felt by the first user is higher as an elapsed time from occurrence of the predetermined event to first execution of the first search is shorter.

20. The information processing method according to claim 14, wherein
the web behavior history information of the first user includes information about a first search that is a search for a web page performed by the first user with the topic as a keyword, and
the information indicating the degree of interest felt by the first user indicates that interest felt by the first user is higher as a time spent by the first user on the first search is longer.
